(19) United States
(12) Patent Application Publication
(10) Pub. No.: US 2023/0102725 A1
(43) Pub. Date: Mar. 30, 2023

(54) BATTERY PACK AND VEHICLE

(71) Applicant: BYD COMPANY LIMITED, Shenzhen (CN)

(72) Inventors: Yue ZHANG, Shenzhen (CN); Yanfei ZHOU, Shenzhen (CN); Zhonglin ZHANG, Shenzhen (CN); Xiaofeng GU, Shenzhen (CN)

(21) Appl. No.: 18/077,612

(22) Filed: Dec. 8, 2022

Related U.S. Application Data
(63) Continuation of application No. PCT/CN2021/093195, filed on May 12, 2021.

(30) Foreign Application Priority Data
Jun. 9, 2020 (CN) 202021060982.0

(51) Int. Cl. H01M 50/264; H01M 50/209

(52) U.S. Cl. CPC H01M 50/264; H01M 50/209

(57) ABSTRACT

A battery pack includes a box body including a mounting space. A cell array is disposed in the mounting space and includes multiple battery cores arranged in a first direction, and the first direction is parallel to a thickness direction of the battery cores. An adjustment shim set includes at least one adjustment shim and is disposed in the mounting space on a first side of the cell array in the first direction, and a first wedge-shaped member is disposed in the mounting space on a second side of the cell array in the first direction or a first side of the at least one adjustment shim away from the cell array, to press the cell array and the adjustment shim set. The number of adjustment shims of the adjustment shim set is configured to generate a pressure on the cell array in the mounting space to reach a pre-tightening force.

### CROSS-REFERENCE TO RELATED APPLICATIONS

This application is a continuation application of international patent application No. PCT/CN2021/093195 filed with the China National Intellectual Property Administration (CNIPA) on May 12, 2021, which is based on and claims the priority to and benefits of the Chinese Patent Application No. 202021060982.0, titled “BATTERY PACK AND VEHICLE”, and filed on Jun. 9, 2020. The entire content of all of the above-referenced applications is incorporated herein by reference.

### FIELD

The present disclosure relates to the technical field of batteries, and specifically to a battery pack and a vehicle.

### BACKGROUND

In the related art, a battery pack is usually designed in a fixed size, that is, after multiple battery cores are arranged in sequence to form cell arrays, an overall thickness of the arranged cell arrays is a fixed value by applying different degrees of initial pre-tightening forces. However, there is a certain difference in a thickness of each battery core due to deviation during manufacturing, which leads to a difference in an overall thickness of the cell array including the same number of battery cores. Thus, in order for the thickness of different cell arrays (each cell array includes the same number of battery cores) reaches a fixed value, it is inevitable to apply different initial pre-tightening forces to the cell arrays, thereby resulting in a difference in cycle performance of the battery cores, and further influencing the cycle service life of the battery cores.

### SUMMARY

In a first aspect, the present disclosure discloses a battery pack, which includes a box body including a mounting space. A cell array is disposed in the mounting space and includes multiple battery cores arranged in a first direction, and the first direction is parallel to a thickness direction of the battery cores. An adjustment shim set includes at least one adjustment shim and is disposed in the mounting space on a first side of the cell array in the first direction, and a first wedge-shaped member is disposed in the mounting space on a second side of the cell array in the first direction or a first side of the at least one adjustment shim away from the cell array, to press the cell array and the adjustment shim set. The number of adjustment shims of the adjustment shim set is configured to generate a pressure on the cell array in the mounting space to reach a pre-tightening force.

According to the battery pack of an embodiment of the present disclosure, the number of adjustment shims is configured such that a pressure on the cell array in the mounting space reaches a predetermined pre-tightening force. That is, the battery pack can adjust the pressure on the cell array in the mounting space by adjusting the number of the adjustment shims, and then the pressure can be adjusted to the predetermined pre-tightening force. Moreover, according to the performance requirements of the battery core, an optimal pressure, i.e., the predetermined pre-tightening force, which can make the battery core have a better cycle time and charge-discharge performance in a life cycle when the cell array is in a pressed state can be determined by experiments in advance. Therefore, for the cell arrays with different thicknesses (each cell array has the same number of battery cores), by controlling the number of the adjustment shims, the pressure applied on each cell array can be the predetermined pre-tightening force, so that the cycle time and charge-discharge performance of the battery core in each cell array can be improved, a mode of the box body can also be improved, and the anti-vibration reliability of the box body can be improved.

According to some embodiments of the present disclosure, a thickness of the first wedge-shaped member decreases along a direction from a top portion of the box body to a bottom portion of the box body.

According to some embodiments of the present disclosure, an inner wall of the box body includes an box inclined surface and a box vertical surface opposite to each other in the first direction, the first wedge-shaped member includes a first fitting inclined surface and a first fitting vertical surface, the first fitting inclined surface is attached to the box inclined surface, and the adjustment shim set is attached to the box vertical surface or the first fitting vertical surface.

According to some embodiments of the present disclosure, the battery pack further includes a second wedge-shaped member disposed in the mounting space between the first wedge-shaped member and the box body, where the first wedge-shaped member includes a first fitting inclined surface and a first fitting vertical surface, the second wedge-shaped member includes a second fitting inclined surface, an inner wall of the box body includes a box vertical surface opposite to a box inclined surface in the first direction, the box vertical surface is on the first side of the cell array away from the second wedge-shaped member, the first fitting inclined surface is attached to the box inclined surface, and the adjustment shim set is attached to the box vertical surface or the first fitting vertical surface.

According to some embodiments of the present disclosure, the number of the adjustment shims is configured such that a sum of a thickness of the adjustment shim set and a thickness of the cell array reaches a predetermined thickness, and the first wedge-shaped member is configured such that a distance between the first fitting vertical surface and the box vertical surface reaches the predetermined thickness.

According to some embodiments of the present disclosure, an initial thickness of the cell array before being pressed is T_{cells′}, the number of the adjustment shims is n, n≥1, and T_{cells′} and n meet a relationship:

$${T}_{cells}^{′} = {T}_{pack} - {T}_{wedge} + \frac{F - {K}_{shim} \cdot Δ {T}_{shims}}{{K}_{cell}} - n \cdot {T}_{shim}$$

where T_{pack} is a minimum distance between the box inclined surface and the box vertical surface in the first direction; Tₛₕᵢₘ is a minimum thickness of the first wedge-shaped member in the first direction; Tₛₕᵢₘ is a thickness of the at least one adjustment shim; K_{cell} is an equivalent stiffness coefficient of the cell array; Kₛₕᵢₘ is a stiffness coefficient of the at least one adjustment shim; ΔTₛₕᵢₘₛ is a compression amount of the at least one adjustment shim; and F is the pre-tightening force.

According to some embodiments of the present disclosure, the battery pack further includes a fixing member connected with the box body to fix the first wedge-shaped member in the mounting space.

According to some embodiments of the present disclosure, the fixing member includes a bolt, the box body includes a screw hole, the first wedge-shaped member includes a fixing hole, the bolt passes through the fixing hole to fit with the screw hole, and one side of the fixing hole away from the cell array is recessed to avoid the bolt.

According to some embodiments of the present disclosure, the battery pack includes multiple fixing members. The multiple fixing members are distributed at intervals in a length direction of the first wedge-shaped member. The length direction of the first wedge-shaped member is parallel to a length direction of the battery core.

According to some embodiments of the present disclosure, the first wedge-shaped member includes weight reduction grooves or weight reduction holes.

According to some embodiments of the present disclosure, a height of the first wedge-shaped member is less than or equal to a height of the cell array.

According to some embodiments of the present disclosure, the battery pack further includes a tightening member. The box body includes a bottom plate and side plates surrounding a periphery of the bottom plate. The bottom plate and the side plates together define the mounting space. The side plates include a first side plate and a second side plate opposite to each other in the first direction. The tightening member is arranged on the top portion of the box body and connects the first side plate with the second side plate.

In a second aspect, the present disclosure includes the above-mentioned battery pack.

Additional aspects and advantages of the present disclosure will be given in the following description, some of which will become apparent from the following description or may be learned from practices of the present disclosure.

### BRIEF DESCRIPTION OF THE DRAWINGS

The foregoing and/or additional aspects and advantages of the present disclosure will become apparent and comprehensible in the description of the embodiments made with reference to the following accompanying drawings.

FIG. 1 is a schematic structural diagram of a battery pack;

FIG. 2 is a schematic diagram of an exploded view of a battery pack;

FIG. 3 is a structural diagram of a battery pack;

FIG. 4 is a schematic structural diagram of a first wedge-shaped member; and

FIG. 5 is a schematic diagram of a relationship between a battery pack and a vehicle.

Reference numerals of the accompanying drawing:

Battery pack S; vehicle Q;

box body 10; mounting space 11; box inclined surface 12; box vertical surface 13; rib 14; side plate 15; first side plate 151; second side plate 152; bottom plate 16;

first wedge-shaped member 21; first fitting inclined surface 211; first fitting vertical surface 212; avoidance hole; 213; weight reduction groove 214; fixing member 22;

adjustment shim set 30; adjustment shim 31; cell array 40; battery core 41; and tightening member 50.

### DETAILED DESCRIPTION

The embodiments of the present disclosure are described in detail below, and the embodiments described with reference to accompanying drawings are exemplary.

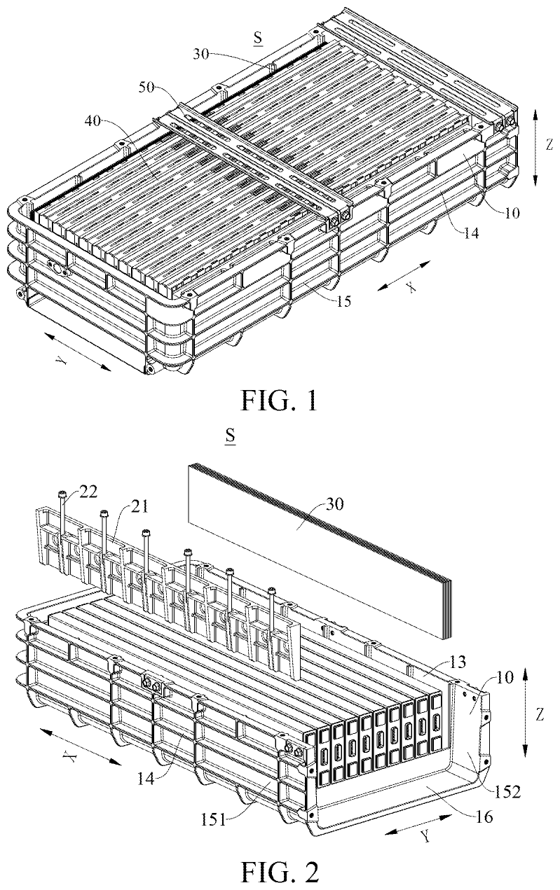

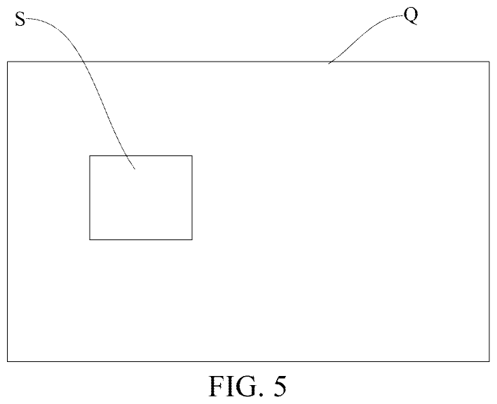

The following describes a battery pack S according to an embodiment of the present disclosure with reference to FIGS. 1 to 5. The present disclosure further discloses a vehicle having the above-mentioned battery pack 5, the battery pack S being used as a power battery.

In combination with those as shown in FIG. 1 and FIG. 4, the battery pack S includes a box body 10, cell arrays 40, a first wedge-shaped member 21 and an adjustment shim set 30. The box body 10 includes a mounting space 11. The cell array 40 is arranged or disposed in the mounting space 11. The box body 10 can support and protect the cell arrays 40. Moreover, the cell array 40 includes multiple battery cores 41 arranged in a preset direction (e.g., a first direction), the preset direction being parallel to a thickness direction of the battery core 41. The battery core 41 is a square battery core. The battery core 41 is defined with a length, a width and a thickness. The length of the battery core 41 is greater than the width of the battery core 41, and the width of the battery core 41 is greater than the thickness of the battery core 41. Moreover, as shown in FIG. 1, a length direction of the battery core 41 is an X direction, a thickness direction of the battery core 41 is a Y direction, and a width direction of the battery core 41 is a Z direction.

In an embodiment, the length direction of the battery core 41 is parallel to a length direction of the battery pack S, and the thickness direction of the battery core 41 is parallel to a width direction of the battery pack S. In another embodiment, the length direction of the battery core 41 may also be parallel to the width direction of the battery pack S, and the thickness direction of the battery core 41 may also be parallel to the length direction of the battery pack S.

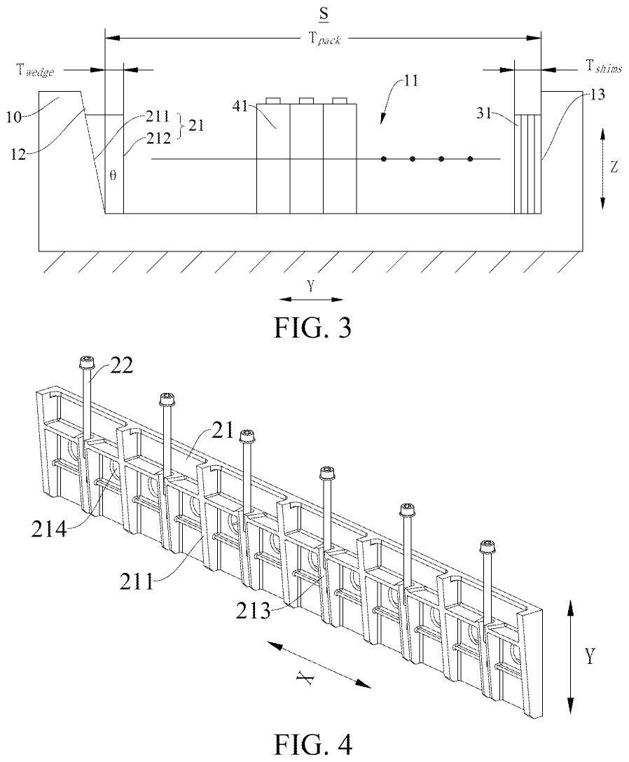

As shown in FIG. 2 and FIG. 3, the adjustment shim set 30 includes at least one adjustment shim 31, and the adjustment shim set 30 is arranged in the mounting space 11 and is arranged on one side of the cell array 40 in the preset direction (i.e., the Y direction). The first wedge-shaped member 21 is arranged in the mounting space 11, and the first wedge-shaped member 21 is arranged on the other side of the cell array 40 in the preset direction or on one side of the adjustment shim set 30 away from the cell array 40 so as to press the cell array 40 and the adjustment shim set 30.

That is, in the Y direction, one side of the first wedge-shaped member 21 abuts against the box body 10, and the other side of the first wedge-shaped member 21 abuts against the adjustment shim set 30 so as to press the cell arrays 40 and the adjustment shim set 30. In an embodiment, one side of the first wedge-shaped member 21 abuts against the box body 10, and the other side of the first wedge-shaped member 21 abuts against the cell array 40 so as to press the cell array 40 and the adjustment shim set 30.

The number of the adjustment shims 31 is configured such that a pressure on the cell array 40 in the mounting space 11 reaches a predetermined pre-tightening force. That is, the number of the adjustment shims 31 can be adjusted to adjust the pressure on the cell array 40 in the mounting space 11 to reach the predetermined pre-tightening force.

According to the performance requirements of the battery core 41, an optimal pressure, i.e., the predetermined pre-tightening force, which can make the battery core 41 have a better cycle time and charge-discharge performance in a life cycle when the cell array 40 is in a pressed state, can be determined by experiments in advance. Therefore, for the cell arrays 40 with different thicknesses (each cell array 40 has the same number of battery cores 41), by controlling the number of the adjustment shims 31, the pressure applied on each cell array 40 can reach the predetermined pre-tightening force, so that the cycle time and charge-discharge performance of the battery core 41 in each cell array 40 can be improved, a mode of the box body 10 can also be improved, and the anti-vibration reliability of the box body 10 can be improved.

As shown in FIG. 4, a thickness of the first wedge-shaped member 21 gradually decreases in a direction from a top portion of the box body 10 to a bottom portion of the box body 10. Since a thickness of the first wedge-shaped member 21 gradually decreases from the top portion of the box body 10 to the bottom portion of the box body 10, when the first wedge-shaped member 21 fits with the box body 10, the first wedge-shaped member 21 can provide a force for the cell array 40 in the Y direction. The pressure on the cell array 40 in the mounting space 11 is controlled by adjusting a position of the first wedge-shaped member 21 relative to the box body 10 and adjusting the number of the adjustment shims 31.

It should be noted that the thickness of the first wedge-shaped member 21 gradually decreases in the direction from the top portion of the box body 10 to the bottom portion of the box body 10. It can be seen from FIG. 4 that the thickness of one end of the first wedge-shaped member 21 is greater than the other end of the first wedge-shaped member 21 in the Y direction. It can be understood that one end of the first wedge-shaped member 21 in the Y direction with a larger thickness at the top portion of the box body 10, and one end of the first wedge-shaped member 21 in the Y direction with a smaller thickness is at the bottom portion of the box body 10.

According to an embodiment of the present disclosure, as shown in FIG. 2 and FIG. 3, an inner wall of the box body 10 includes a box inclined surface 12 and a box vertical surface 13 opposite to each other in the preset direction. The first wedge-shaped member 21 includes a first fitting inclined surface 211 and a first fitting vertical surface 212. The first fitting inclined surface 211 is attached to the box inclined surface 12. The adjustment shim set 30 is attached to the box vertical surface 13 or the first fitting vertical surface 212. That is, the adjustment shim set 30 can be arranged between the first fitting vertical surface 212 of the first wedge-shaped member 21 and the cell array 40, or can be arranged between the cell array 40 and the box vertical surface 13 of the box body 10. The inner wall of the box body 10 is two inner surfaces of the box body 10 opposite to each other in the Y direction. Moreover, a normal direction of the box vertical surface 13 is parallel to the Y direction.

According to another embodiment of the present disclosure, the battery pack S further includes a second wedge-shaped member (not shown in the figures) arranged or disposed in the mounting space 11. The second wedge-shaped member is arranged between the first wedge-shaped member 21 and the box body 10. The second wedge-shaped member includes a second fitting inclined surface, and the inner wall of the box body 10 includes the box vertical surface 13 opposite to the box inclined surface in the preset direction. The box vertical surface 13 is arranged on one side of the cell array 40 away from the second wedge-shaped member. The first wedge-shaped member 21 includes the first fitting inclined surface 211 and the first fitting vertical surface 212. The first fitting inclined surface 211 is attached to the box inclined surface. The adjustment shim set 30 is attached to the box vertical surface 13 or the first fitting vertical surface 212.

Thus, when the first wedge-shaped member 21 moves downwards in the box body 10, a pressure in the Y direction can be applied to the cell array 40. The pressure on the cell array 40 in the mounting space 11 is controlled through fitting of the first wedge-shaped member 21 and the adjustment shim set 30.

In an embodiment, the number of the adjustment shims 31 is configured such that the sum of dimensions of the adjustment shim set 30 and the pressed cell array 40 in the Y direction reaches a predetermined thickness. The first wedge-shaped member 21 is configured such that the distance between the first fitting vertical surface 212 and the box vertical surface 13 reaches a predetermined thickness, so that the pressure on the cell array 40 in the mounting space 11 reaches the predetermined pre-tightening force.

Before assembly, a set of standard cell arrays 40 (i.e., the thickness of each battery core 41 in the cell array 40 is a standard value) can be first pressed by tooling. When the pressure on the standard cell array 40 reaches the predetermined pre-tightening force, a size of the cell array 40 in the Y direction is the predetermined thickness, and the pressure on the cell array 40 can be obtained by detecting the pressure at the tooling. Similarly, before assembly, a set of cell arrays 40 to be mounted (the cell array 40 has a different thickness from the above-mentioned standard cell array 40, but has the same number of battery cores 41, and the different thickness is due to an error caused by being pressed during manufacturing of each battery core 41). When the pressure on the cell array 40 is the predetermined pre-tightening force, thickness of the cell array 40 is measured. When the measured thickness is less than the predetermined thickness, the number of the adjustment shims 31 (i.e., the adjustment shim set 30) can be determined according to a difference between the predetermined thickness and the measured thickness, so that the sum of the sizes of the adjustment shim set 30 and the pressed cell array 40 in the Y direction is the predetermined thickness. During assembly, the cell array 40 to be mounted and the predetermined number of the adjustment shims 31 (i.e., the adjustment shim set 30) can be first mounted into the mounting space 11, then the first wedge-shaped member 21 is inserted into the mounting space 11. Since the distance between the first fitting vertical surface 212 of the first wedge-shaped member 21 and the box vertical surface 13 of the box body 10 in the preset direction (i.e., the Y direction) is the predetermined thickness, the first wedge-shaped member 21 can press the cell arrays 40 after being inserted into the mounting space 11, so that the sum of the sizes of the adjustment shim set 30 and the pressed cell arrays 40 in the Y direction reaches the predetermined thickness. At this time, the pressure on the cell array 40 is the predetermined pre-tightening force.

In another embodiment, during assembly, the first wedge-shaped member 21 can be first inserted into the mounting space 11, and the adjustment shim 31 is then inserted, and the pressure on the cell array 40 in the mounting space 11 can be monitored in real time when the adjustment shim 31 is inserted. When the measured pressure on the cell array 40 reaches the predetermined pre-tightening force, the number of adjustment shims 31 is adjusted so that the pressure on the cell array 40 in the mounting space 11 can be the predetermined pre-tightening force.

According to an embodiment of the present disclosure, the initial thickness of the cell array 40 before being pressed is T_{cells′}, the number of the adjustment shims 31 is n, n≥1, and T_{cells′} and n meet the following relationship:

$${T}_{cells}^{′} = {T}_{pack} - {T}_{wedge} + \frac{F - {K}_{shim} \cdot Δ {T}_{shims}}{{K}_{cell}} - n \cdot {T}_{shim}$$

Where:

T_{pack} is a minimum distance (mm) between the box inclined surface and the box vertical surface in the preset direction;

T_{wedge} is a minimum thickness (mm) of the first wedge-shaped member 21 in the preset direction;

Tₛₕᵢₘ is a thickness (mm) of the adjustment shim 31;

K_{cell} is an equivalent stiffness coefficient of the cell array 40 (the value thereof >0);

Kₛₕᵢₘ is a stiffness coefficient of the adjustment shim 31 (the value thereof >0);

ΔTₛₕᵢₘₛ is a compression amount of the adjustment shim 31; and

F is a pre-tightening force design value (N).

A wedge angle θ of the first wedge-shaped member 21 is configured to guarantee assembly operations, and does not involve in an adjustment of the magnitude of the pre-tightening force F.

In an embodiment, a method for determining the number of the adjustment shims 31 of the adjustment shim set 30 is as follows: before assembly, a set of standard cell arrays 40 can be first pressed by tooling. When the pressure on the standard cell array 40 reaches the predetermined pre-tightening force, a thickness of the cell array 40 is the predetermined thickness, and the pressure on the cell array 40 can be obtained by detecting the pressure at the tooling. Similarly, before assembly, a set of cell arrays 40 to be mounted (the cell array 40 has a different thickness from the above-mentioned standard cell array 40, but has the same number of battery cores 41, and the different thickness is due to an error caused by being pressed during manufacturing of each battery core 41). When the pressure on the cell array 40 reaches the predetermined pre-tightening force, the thickness of the cell array 40 is measured. When the measured thickness is less than the predetermined thickness, the number of the adjustment shims 31 (i.e., the adjustment shim set 30) can be determined according to a difference between the predetermined thickness and the measured thickness. It should be noted that the amount of deformation of the adjustment shim 31 is very small. Therefore, ΔTₛₕᵢₘₛ can be ignored. The adjustment shim 31 can be selected as a metal sheet, such as a steel sheet.

As shown in FIG. 4, the battery pack S further includes a fixing member 22. The fixing member 22 is connected with the box body 10 to fix the first wedge-shaped member 21 in the mounting space 11. The first wedge-shaped member 21 can be fixed in the mounting space 11 by the fixing member 22, so that the first wedge-shaped member 21 will not change its position relative to the box body 10. Thus, the cell array 40 can be subjected to a constant pre-tightening force.

In an embodiment, the fixing member 22 is a bolt. The box body 10 includes a screw hole. The first wedge-shaped member 21 includes a fixing hole. The bolt passes through the fixing hole so as to fit with the screw hole. One side of the fixing hole away from the cell array 40 includes an avoidance hole 213 to avoid the bolt. The box body 10 and the first wedge-shaped member 21 are connected by the bolts, so that the connection strength between the box body 10 and the first wedge-shaped member 21 can be improved, such that the first wedge-shaped member 21 will not be separated from the box body 10 when the battery pack S is in use. Moreover, in a process of tightening the bolts, the first wedge-shaped member 21 will move towards the bottom portion of the box body 10, and moves towards the cell array 40 at the same time. However, in this process, the bolts only move towards the bottom portion of the box body 10, and do not move towards the cell array 40, so that the first wedge-shaped member 21 also moves towards the cell array 40 with respect to the bolt in the assembly process. Therefore, one side of the fixing hole away from the cell array 40 includes an avoidance hole 213, which can avoid that the first wedge-shaped member 21 interferes with the bolts in the process of moving towards the cell array 40. In other embodiments, the fixing hole in the first wedge-shaped member 21 can also be designed as an elongated hole, so that the bolt can be avoided by controlling the length of the hole, without the avoidance hole 213.

The box body 10 includes a bottom plate 16 and side plates 15 surrounding the bottom plate 16. The bottom plate 16 and the side plates 15 together define the mounting space 11. The screw hole may be provided in the bottom plate 16, or the bottom plate 16 of the box body 10 may include a mounting plate or a mounting block, and the screw hole is provided in the mounting plate or the mounting block, which is not limited in the present disclosure.

Moreover, as shown in FIG. 4, the battery pack S includes multiple fixing members 22. The multiple fixing members 22 are distributed at intervals in the length direction of the first wedge-shaped member 21 (i.e., the X direction). The length direction of the first wedge-shaped member 21 is parallel to the length direction of the battery core 41. By arranging the multiple fixing members 22, the connection stability between the first wedge-shaped member 21 and the box body can be improved, which prevents that a portion of the first wedge-shaped member 21 moves in the Z direction. In another embodiment, the fixing member 22 is a pressing plate. The pressing plate is connected with the box body 10 and is pressed on a top portion of the first wedge-shaped member 21. In this way, the pressing plate is directly pressed on the top portion of the first wedge-shaped member 21, which not only can guarantee the connection strength between the first wedge-shaped member 21 and the box body 10, but also facilitates the connection between the first wedge-shaped member 21 and the box body 10.

In yet another embodiment, the fixing member 22 is a buckle. The buckle is arranged on the first wedge-shaped member 21. The buckle is clipped on the box body 10. By arranging the buckle on the first wedge-shaped member 21 and fixing the first wedge-shaped member 21 onto the box body 10 by clipping, the detachment and connection between the first wedge-shaped member 21 and the box body 10 can be facilitated, to further facilitate the production and maintenance of the battery pack S.

As shown in FIG. 4, weight reduction grooves 214 or weight reduction holes are distributed in the first wedge-shaped member 21. By distributing the weight reduction grooves 214 or weight reduction holes in the first wedge-shaped member 21, the weight of the first wedge-shaped member 21 can be reduced, to achieve a lightweight design of the battery pack S.

According to an embodiment of the present disclosure, a height of the first wedge-shaped member 21 (i.e., the size of the first wedge-shaped member 21 in the Z direction) is less than or equal to that of the cell array 40 (i.e., the size of the cell array 40 in the Z direction). When a bottom portion of the first wedge-shaped member 21 is in contact with the bottom portion of the box body 10, the size of the first wedge-shaped member 21 in the Z direction may be equal to the size of the cell array 40 in the Z direction. At this time, the cell array 40 may be subjected to a uniform pre-tightening force in the Z direction. When the first wedge-shaped member 21 is not in contact with the bottom portion of the box body 10, it is necessary to guarantee that the first wedge-shaped member 21 will not extend beyond the cell array 40 in the Z direction. Therefore, the size of the first wedge-shaped member 21 in the Z direction is smaller than that of the cell array 40 in the Z direction.

As shown in FIG. 1 and FIG. 2, the battery pack S further includes a tightening member 50. The box body 10 includes a bottom plate 16 and side plates 15 surrounding a periphery of the bottom plate 16. The bottom plate 16 and the side plates 15 together define the mounting space 11. The side plates 15 include a first side plate 151 and a second side plate 152 oppositely arranged in the preset direction. The tightening member 50 is arranged on the top portion of the box body 10 and connects the first side plate 151 with the second side plate 152. When the first wedge-shaped member 21 and the adjustment shim set 30 cooperate to pre-tighten the cell array 40, the first wedge-shaped member 21 applies pressure to the first side plate 151 and the second side plate 152. The first side plate 151 and the second side plate 152 can be fixedly connected together by the tightening member 50, so that the bearing capacity of the box body 10 can be improved, which prevents that the box body 10 is damaged by the force.

As shown in FIG. 1 and FIG. 2, multiple ribs 14 are arranged on an outer side of the box body 10. By arranging the multiple ribs 14 on the outer side of the box body 10, the structural strength of the box body 10 can be improved.

Also, according to the vehicle Q of an embodiment of the second aspect of the present disclosure, the vehicle Q includes the above-mentioned battery pack S, and the battery pack S is used as a power battery on the vehicle Q.

In the description of the present disclosure, it should be understood that, orientations or position relationships indicated by terms such as “center”, “longitudinal”, “transverse”, “length”, “width”, “thickness”, “up”, “down”, “front”, “back”, “left”, “right”, “vertical”, “horizontal”, “top”, “bottom”, “inner”, “outer”, “clockwise”, “counterclockwise”, “axial”, “radial”, and “circumferential” are orientations or position relationship shown based on the accompanying drawings, and are merely used for describing the present disclosure and simplifying the description, rather than indicating or implying that the apparatus or element should have a particular orientation or be constructed and operated in a particular orientation, and therefore, should not be construed as a limitation on the present disclosure.

In the descriptions of this specification, descriptions using reference terms “an embodiment”, “some embodiments”, “an exemplary embodiment”, “an example”, “a specific example”, or “some examples” mean that specific characteristics, structures, materials, or features described with reference to the embodiment or example are included in at least an embodiment or example of the present disclosure. In this specification, schematic descriptions of the foregoing terms do not necessarily refer to the same embodiment or example.

Although the embodiments of the present disclosure have been shown and described, a person of ordinary skill in the art should understand that various changes, modifications, replacements and variations may be made to the embodiments without departing from the principles and spirit of the present disclosure, and the scope of the present disclosure is as defined by the appended claims and their equivalents.

What is claimed is:

1. A battery pack, comprising:
a box body comprising a mounting space;
a cell array disposed in the mounting space and comprising a plurality of battery cores arranged in a first direction, and the first direction being parallel to a thickness direction of the battery cores;
an adjustment shim set comprising at least one adjustment shim and disposed in the mounting space on a first side of the cell array in the first direction; and
a first wedge-shaped member being disposed in the mounting space on a second side of the cell array in the first direction or a first side of the at least one adjustment shim away from the cell array, to press the cell array and the adjustment shim set,
wherein a number of adjustment shims of the adjustment shim set is configured to generate a pressure on the cell array in the mounting space to reach a pre-tightening force.

2. The battery pack according to claim 1, wherein a thickness of the first wedge-shaped member decreases along a direction from a top portion of the box body to a bottom portion of the box body.

3. The battery pack according to claim 1, wherein an inner wall of the box body comprises an box inclined surface and a box vertical surface opposite to each other in the first direction, the first wedge-shaped member comprises a first fitting inclined surface and a first fitting vertical surface, the first fitting inclined surface is attached to the box inclined surface, and the adjustment shim set is attached to the box vertical surface or the first fitting vertical surface.

4. The battery pack according to claim 1, further comprising a second wedge-shaped member disposed in the mounting space between the first wedge-shaped member and the box body, wherein the first wedge-shaped member comprises a first fitting inclined surface and a first fitting vertical surface, the second wedge-shaped member comprises a second fitting inclined surface, an inner wall of the box body comprises a box vertical surface opposite to a box inclined surface in the first direction, the box vertical surface is on the first side of the cell array away from the second wedge-shaped member, the first fitting inclined surface is attached to the box inclined surface, and the adjustment shim set is attached to the box vertical surface or the first fitting vertical surface.

5. The battery pack according to claim 3, wherein the number of the adjustment shims is configured such that a sum of a thickness of the adjustment shim set and a thickness of the cell array reaches a predetermined thickness, and the first wedge-shaped member is configured such that a distance between the first fitting vertical surface and the box vertical surface reaches the predetermined thickness.

6. The battery pack according to claim 3, wherein an initial thickness of the cell array before being pressed is T_{cells′}, the number of the adjustment shims is n, n≥1, and T_{cells′} and n meet a relationship:
$${T}_{cells}^{′} = {T}_{pack} - {T}_{wedge} + \frac{F - {K}_{shim} \cdot Δ {T}_{shims}}{{K}_{cell}} - n \cdot {T}_{shim}$$
wherein,
T_{pack} is a minimum distance between the box inclined surface and the box vertical surface in the first direction;
T_{wedge} is a minimum thickness of the first wedge-shaped member in the first direction;
Tₛₕᵢₘ is a thickness of the at least one adjustment shim;
K_{cell} is an equivalent stiffness coefficient of the cell array;
Kₛₕᵢₘ is a stiffness coefficient of the at least one adjustment shim;
ΔTₛₕᵢₘₛ is a compression amount of the at least one adjustment shim; and
F is the pre-tightening force.

7. The battery pack according to claim 1, further comprising a fixing member connected with the box body to fix the first wedge-shaped member in the mounting space.

8. The battery pack according to claim 7, wherein the fixing member comprises a bolt, the box body comprises a screw hole, the first wedge-shaped member comprises a fixing hole, the bolt passes through the fixing hole to fit with the screw hole, and one side of the fixing hole away from the cell array is recessed to avoid the bolt.

9. The battery pack according to claim 7, further comprising a plurality of fixing members including the fixing member, wherein the plurality of fixing members are distributed at intervals in a length direction of the first wedge-shaped member, and the length direction of the first wedge-shaped member is parallel to a length direction of the battery core.

10. The battery pack according to claim 1, wherein the first wedge-shaped member comprises weight reduction grooves or weight reduction holes.

11. The battery pack according to claim 1, wherein a height of the first wedge-shaped member is less than or equal to a height of the cell array.

12. The battery pack according to claim 1, further comprising a tightening member, wherein the box body comprises a bottom plate and side plates surrounding a periphery of the bottom plate, and the bottom plate and the side plates together define the mounting space; and the side plates comprise a first side plate and a second side plate opposite to each other in the first direction, and the tightening member is arranged on the top portion of the box body and connects the first side plate and the second side plate.

13. A vehicle, comprising a battery pack comprising:
a box body comprising a mounting space;
a cell array disposed in the mounting space and comprising a plurality of battery cores arranged in a first direction, and the first direction being parallel to a thickness direction of the battery cores;
an adjustment shim set comprising at least one adjustment shim, and being disposed in the mounting space on a first side of the cell array in the first direction; and
a first wedge-shaped member disposed in the mounting space on a second side of the cell array in the first direction or a first side of the at least one adjustment shim away from the cell array, to press the cell array and the adjustment shim set,
wherein a number of adjustment shims of the adjustment shim set is configured to generate a pressure on the cell array in the mounting space to reach a pre-tightening force.

14. The vehicle according to claim 13, wherein a thickness of the first wedge-shaped member decreases along a direction from a top portion of the box body to a bottom portion of the box body.

15. The vehicle according to claim 13, wherein an inner wall of the box body comprises an box inclined surface and a box vertical surface opposite to each other in the first direction, the first wedge-shaped member comprises a first fitting inclined surface and a first fitting vertical surface, the first fitting inclined surface is attached to the box inclined surface, and the adjustment shim set is attached to the box vertical surface or the first fitting vertical surface.

16. The vehicle according to claim 13, wherein the battery pack further comprises a second wedge-shaped member disposed in the mounting space between the first wedge-shaped member and the box body, wherein the first wedge-shaped member comprises a first fitting inclined surface and a first fitting vertical surface, the second wedge-shaped member comprises a second fitting inclined surface, an inner wall of the box body comprises a box vertical surface opposite to a box inclined surface in the first direction, the box vertical surface is on the first side of the cell array away from the second wedge-shaped member, the first fitting inclined surface is attached to the box inclined surface, and the adjustment shim set is attached to the box vertical surface or the first fitting vertical surface.

17. The vehicle according to claim 15, wherein the number of the adjustment shims is configured such that a sum of a thickness of the adjustment shim set and a thickness of the cell array reaches a predetermined thickness, and the first wedge-shaped member is configured such that a distance between the first fitting vertical surface and the box vertical surface reaches the predetermined thickness.

18. The vehicle according to claim 15, wherein an initial thickness of the cell array before being pressed is T_{cells′}, the number of the adjustment shims is n, n≥1, and T_{cells′} and n meet a relationship:
$${T}_{cells}^{′} = {T}_{pack} - {T}_{wedge} + \frac{F - {K}_{shim} \cdot Δ {T}_{shims}}{{K}_{cell}} - n \cdot {T}_{shim}$$
wherein,
Tₚₑₐₖ is a minimum distance between the box inclined surface and the box vertical surface in the first direction;
T_{wedge} is a minimum thickness of the first wedge-shaped member in the first direction;
Tₛₕᵢₘ is a thickness of the at least one adjustment shim;
K_{cell} is an equivalent stiffness coefficient of the cell array;
Kₛₕᵢₘ is a stiffness coefficient of the at least one adjustment shim;
ΔTₛₕᵢₘₛ is a compression amount of the at least one adjustment shim; and
F is the pre-tightening force.

19. The vehicle according to claim 13, wherein the battery pack further comprises a fixing member connected with the box body to fix the first wedge-shaped member in the mounting space.

20. The vehicle according to claim 13, wherein the fixing member comprises a bolt, the box body comprises a screw hole, the first wedge-shaped member comprises a fixing hole, the bolt passes through the fixing hole to fit with the screw hole, and one side of the fixing hole away from the cell array is recessed to avoid the bolt.
